(19) United States
(12) Patent Application Publication
(10) Pub. No.: US 2022/0206236 A1
(43) Pub. Date: Jun. 30, 2022

(54) ADHESIVE TAPE JACKETED COMMUNICATION CABLE

(71) Applicant: CommScope Technologies LLC, Hickory, NC (US)

(72) Inventors: Christopher P. GEMME, Hickory, NC (US); Mark O. Vogel, Statesville, NC (US); Eric E. Alston, Mooresville, NC (US)

(21) Appl. No.: 17/564,718

(22) Filed: Dec. 29, 2021

Related U.S. Application Data
(60) Provisional application No. 63/131,929, filed on Dec. 30, 2020.

(51) Int. Cl. G02B 6/44; C09J 7/20; C09J 7/35; C09J 7/38; C09J 5/06

(52) U.S. Cl. CPC G02B 6/443; G02B 6/4486; C09J 7/20; C09J 2301/204; C09J 7/38; C09J 5/06; C09J 2203/302; C09J 7/35

(57) ABSTRACT

A communication cable is surrounded by a tape with overlapped first and second longitudinal edges. The overlapped portion of the tape extends parallel to the longitudinal length of the communication cable, which is also parallel to the longitudinal central axis of the cable core. An attachment is provided between the overlapped portions of the tape. The attachment may be formed by an adhesive layer between the overlapped portions of the tape or a melting together of the overlapped portions of the tape. In either case, the tape forms a circumferential protective seal around the cable core.

This application claims the benefit of U.S. Provisional Application No. 63/131,929, filed Dec. 30, 2020, which is herein incorporated by reference.

### FIELD OF THE INVENTION

The present invention relates to an adhesive tape and a communication cable wrapped by the tape. More particularly, the present invention relates to communication cable, such as a fiber optic cable or a twisted pair cable or a hybrid cable, with a longitudinally applied tape serving as a jacketing layer. The tape includes overlapped edges which are attached to each other and extend in the longitudinal direction of the cable to secure the tape to itself while encircling a cable core.

### BACKGROUND OF THE INVENTION

It is often desirable to bundle a plurality of communication carrying mediums together, such as buffer tubes with optical fibers, twisted pairs of insulated conductors, coaxial conductors, insulated power conductors and combinations thereof. The most typical method in a factory setting is to bring the desired communication carrying mediums together into a bundle commonly known as a cable core. The cable core may optionally be stranded, such as by a SZ stranding machine, during the bundling operation, and paper wraps and/or helical threads may be applied around the cable core. The cable core is then passed through an extruder and a plastic jacket, e.g., a PVC jacket, is extruded over the cable core. Often, the PVC jacket is very rugged and can withstand long term exposure to the elements, corrosive fluids, contact with hard or sharp objects, etc.

In the field, it has also been known to manually bundle plural communication carrying mediums together. For example, when several different communication carrying mediums are simultaneously installed into a conduit, the communication carrying mediums may be manually wrapped with an adhesive tape, e.g., black electrical tape, that adheres to the mediums via an adhesive layer on a first side of the tape. The tape is commonly wrapped on the communication cable in a helical manner such that each rotation partially overlaps the prior rotation to form an overlapping helix, with some of the adhesive layer attaching the first surface of the tape to a second surface of the tape and most of the adhesive layer attaching the first surface of the tape to the cable core. In other cases, the tape is simply wrapped radially around the cable core at spaced intervals to form spaced rings of tape. The inner wrapping of tape has all of the adhesive layer of the first surface of the tape in contact with the cable core and the additional wrappings of tape have all of the adhesive of the first surface of the tape in contact with the second surface of the tape. The spaced rings of tape hold the cable core together as it is pulled or pushed through the conduit, pulled up a tower, or otherwise installed.

These tape wrapping styles create several drawbacks. First, the adhesive layer may degrade and harm the communication carrying mediums. Second, the adhesive layer may remain as a residue on the cable core after the tape has been removed, which can cause dust, dirt and/or debris to stick to the cable core and hinder further routing of the mediums, as well as terminations and splicing of the mediums. Third, the helical wrapping of the tape around the cable core means that significantly more square footage of tape is needed per unit length of the cable core, because the overlapped section of the tape spirals along the length of the cable core, as compared to a linearly extending overlapped section of the tape. Fourth, helical wrapping is typically done by hand and would be difficult to automate. A helical wrapping apparatus would not be well suited to the linear speeds associated with the bundling, e.g., stranding, of communication carrying mediums in a factory environment where cables are produced.

U.S. Pat. No. 4,375,313, which is herein incorporated by reference, shows an adhesive tape jacket in accordance with a first embodiment of the prior art. The entirety of one side of the tape is formed as an adhesive layer. The tape is wound in an overlapped helix around a cable core formed of plural communication cables. The tape jacket of U.S. Pat. No. 4,375,313 would suffer all four of the drawbacks previously mentioned.

The U.S. Pat. No. 9,725,622, which is herein incorporated by reference, relates to an adhesive tape jacket in accordance with a second embodiment of the prior art. An adhesive strip is formed on an edge of the first side of the tape. The tape is wound in an overlapped helix around a cable core formed of plural communication carrying mediums. The adhesive strip only exists in the overlapped portion of the helix so that the adhesive strip does not contact the cable core, but only contacts the second side of the tape. Hence, U.S. Pat. No. 9,725,622 addresses the first and second drawbacks previously mentioned.

However, the third and fourth drawbacks are still present in U.S. Pat. No. 9,725,622, as the tape is applied in a helical manner about the cable core and is manually applied to the cable core within a vehicle after the cable core has been installed in the vehicle. As a result, the tape is provided in short lengths and attached in spaced-apart helical bindings or radial bindings to merely secure the cable core together. Hence, U.S. Pat. No. 9,725,622 is not teaching a tape functioning as a jacket for a cable core, but rather spaced apart bindings, which leave the cable core exposed in various sections. Additional prior art can be seen in U.S. Pat. Nos. 4,284,842; 4,750,805; 4,555,054; and 9,316,802, each of which is herein incorporated by reference

### SUMMARY OF THE INVENTION

It is an object of the present invention to address one or more of the drawbacks of the prior art. In particular, the tape of the invention may be applied longitudinally at equal speed to the unwinding of the cable core from a reel. The tape may be secured to itself via adhesive that is placed so that after wrapping on the cable, the adhesive is only disposed between sections of the tape itself. The tape may also advantageously form a weather-tight seal and be heat-shrunk to form-fit the communication cable.

It is an object to provide a tape jacket for a cable core, which is less robust than a PVC jacket, so as to spare the costs and manufacturing difficulties associated with extruding a PVC jacket onto a cable core during a manufacturing process. Such a tape-jacketed cable would be well suited for applications, where the cable is ultimate installed in low-risk environments, like the last hundreds of feet of cable used in a FTTx (“Fiber to the x,” where x may stand for home, business, curb, etc.) network. Often times such deployments are within sealed conduits, plenum, drop ceilings, etc. where exposure is not an issue, and a very robust PVC jacket is not needed.

The various tapes of the prior art that are applied helically may only be applied slowly and not at a linear speed equal to the traversal of a cable core during a cable fabrication process. In addition, those tapes where the entirety of one side of the tape has an adhesive layer may leave residue on the cable core. This makes manufacturing slower and installation by a cable technician slower and messier.

It is a further object of the invention to provide a cable with a tape covering, which can be easily opened in the field to gain access to the cable core for a splicing operation. It is a further object to provide cable tape, which can be applied to the splice point or splice unit so as to re-seal the cable core after the splicing operation. It is yet a further object of the invention to provide a tape which is easily removable from the cable core without leaving adhesive residue of the cable core.

These and other objects are accomplished by a communication cable comprising: a core including at least one communication carrying medium; a tape having first and second longitudinal edges, said first and second longitudinal edges extending parallel to a central axis of said core; and an adhesive layer disposed on a first side of said tape in a first portion proximate said first longitudinal edge, a second portion of said tape proximate said second longitudinal edge overlapping said adhesive layer proximate said first longitudinal edge, such that said second portion is adhered to said first portion and said tape encloses said core along a length of said communication cable.

Further, these and other objects are accomplished by a communication cable comprising: a core including at least one communication carrying medium; a tape having first and second longitudinal edges, said first and second longitudinal edges extending parallel to a central axis of said core, wherein a first portion is disposed on a first side of said tape proximate said first longitudinal edge and overlaps a second portion disposed on a second side of said tape proximate said second longitudinal edge; and an attachment formed between said first and second portions, such that said tape encloses said core along a length of said communication cable.

Moreover, these and other objects are accomplished by a method of applying a tape to a cable core, comprising: advancing the cable core along a first path following a longitudinal axis of the cable core; advancing the tape along a second path to intersect the first path, the tape having a first longitudinal edge and a second longitudinal edge; engaging the tape with one or more first guide elements as the tape is advancing, the one or more first guide element causing a central portion of the tape between the first and second longitudinal edges of the tape to engage the cable core; engaging the tape with one or more second guide elements to move the first and second longitudinal edges of the tape toward each other so as partially encircle the cable core; engaging the tape with one or more third guide elements to press a first portion disposed on a first side of the tape proximate the first longitudinal edge against a second portion disposed on a second side of the tape proximate the second longitudinal edge so as to fully encircle the cable core; and attaching the first and second portions together so that the tape seals the cable core.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus, are not limits of the present invention, and wherein:

FIG. 1 is a perspective view of a fiber cable, in accordance with the present invention;

FIG. 2A is a side view of a first side of a tape, in accordance with the present invention;

FIG. 2B is a side view of a second side of the tape of FIG. 2A;

FIG. 3 is a communication cable with the tape of FIGS. 2A and 2B applied thereto and a mid-section of the tape removed to expose a cable core therein;

FIG. 4 is a perspective view of a twisted-pair cable that is jacketed by the tape of FIGS. 2A and 2B;

FIG. 5 is a cross sectional view taken along line I-I in FIG. 4;

FIG. 6 is a manufacturing system for the application of the tape, according to the present invention;

FIG. 7A is a cross-sectional view showing guide elements and the tape during a wrapping process of a cable core from the perspective of line II-II in FIG. 6;

FIG. 7B is a cross-sectional view showing guide elements and the tape during a wrapping process of the cable core from the perspective of line III-III in FIG. 6;

FIG. 7C is a cross-sectional view showing guide elements and the tape during a wrapping process of the cable core from the perspective of line IV-IV in FIG. 6;

FIG. 7D is a cross-sectional view showing guide elements and the tape during a wrapping process of the cable core from the perspective of line V-V in FIG. 6;

FIG. 8 is a cross-sectional view of a guide profile to support the guide elements of FIGS. 7a-7D;

FIG. 8A is a perspective view of the guide profile of FIG. 8; and

FIG. 9 is a flow chart of a method of jacketing a cable core with tape to form a communication cable, according to an the present invention.

### DETAILED DESCRIPTION OF THE DRAWINGS

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

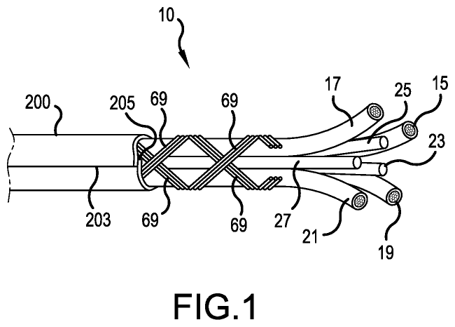

FIG. 1 depicts a cable 10, in accordance with the present invention. The cable 10 includes a cable core with a plurality of buffer tubes, such as first, second, third and fourth buffer tubes 15, 17, 19 and 21. Each buffer tube would include one or more optical fibers, such as one, eight, twelve or twenty-four optical fibers. One or more filler rods, such as first, second and third filler rods 23, 25 and 27 may optionally being included in the cable core, making the cable 10 a fiber optic cable. Alternatively, one or more of the first, second and third filler rods 23, 25 and 27 may be replaced with a jacketed conductor, which may be used for communication signaling or to supply power, making the cable 10 a hybrid cable. One or more binders 69, such as Kevlar® threads, may be employed to hold the elements of the cable core together during a manufacturing process, and hence are also considered part of the cable core.

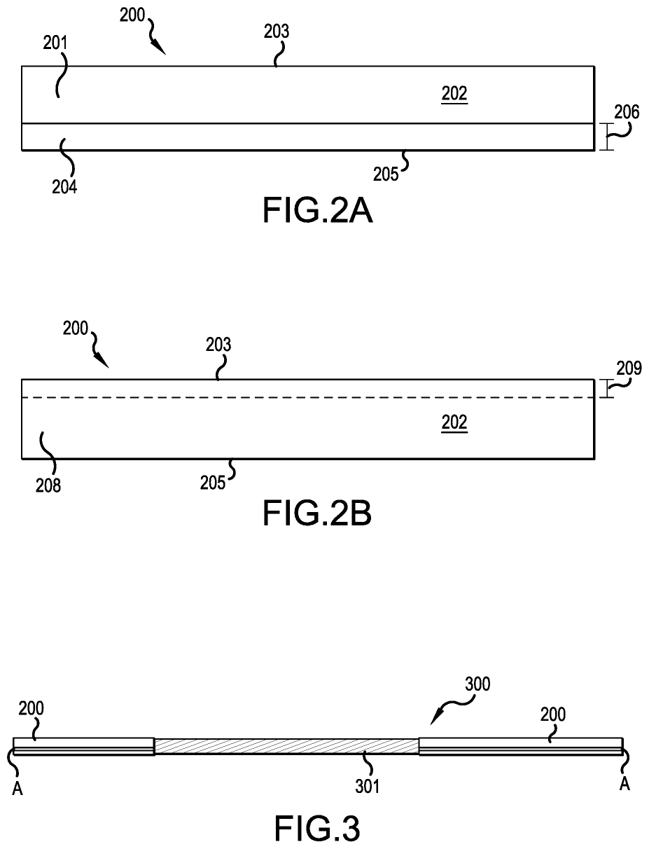

A tape 200 encloses or encircles the cable core. FIG. 2A depicts a first side 201 of the tape 200, while FIG. 2B depicts a second side 208 of the tape 200. The tape 200 is formed as a sheet 202 having parallel first and second longitudinal edges 205 and 203. The tape 200 may be hundreds or thousands of feet long in the longitudinal direction and may be stored in a coil on a spool, e.g. a roll of tape. A width of the tape 200, between the first and second longitudinal edges 205 and 203 could be set in the range of 0.5 to 3 inches, such as 0.75 to 2 inches, for example 1 to 1.25 inches. Tapes of different widths may be employed in accordance with the present invention depending upon a cable core diameter. A thickness of the tape 200 could be set in the range of 3 to 25 mils, such as 5 to 20 mils, for example 8 to 15 mils. Tapes of different thicknesses may be employed in accordance with the present invention depending upon the known deployment environment for the cable.

The first side 201 of the tape 200 has a first portion 206 proximate the first longitudinal edge 205, where the first portion 206 is covered with an adhesive layer 204. The second side 208 of the tape 200 has a second portion 209, which in a first embodiment does not include any adhesive layer. In the first embodiment, the second portion 209 is formed as a surface to which the adhesive layer 204 of the first portion 206 will strongly adhere. However, the other portions of the second side 208 of the tape 200, besides the second portion 209, are formed of a material to which the adhesive layer 204 of the first portion 206 will not strongly adhere (or not adhere to at all), so that the roll of tape 200 will be able to be easily paid off of the spool. This may be accomplished by application of a release agent, such as a wax coating, fluorination layer, Teflon® coating or polished surface, on the second side 208 of the sheet 202 in the areas outside of the second portion 209.

As shown in FIG. 1, the first side 201 may form the outside face of the tape 200, which is exposed and faces away from the cable core. In this configuration, the adhesive layer 204 of the first portion 206 faces outwardly away from the cable core and is overlapped by the second portion 209. Alternatively, the first side 201 may form the inside face of the tape 200, which contacts or faces a cable core. In this configuration, the adhesive layer 204 of the first portion 206 faces toward the cable core and is underlapped by the second portion 209 so as to not contact the cable core.

To form the cable 10, the cable core is placed against the sheet 202, parallel to the first and second longitudinal edges 205 and 203, in a location between the first portion 206 of the sheet 202 and the second longitudinal edge 203. The sheet 202 is wrapped completely around the cable core before the adhesive layer 204 of the first portion 206 is engaged to the second portion 209, proximate the second longitudinal edge 203. The adhesive layer 204 need not engage the second portion 209 “directly at” the second longitudinal edge 203, but may engage the second portion 209 a distance away from the second longitudinal edge 203, further towards a longitudinal center of the sheet 202 in order to form a tight fit about the cable core, e.g., for smaller diameter cables. As such, one width size of the tape 200 may be used on cable cores within a range of diameters.

The adhesive layer 204 may be pressure-activated (e.g., gummy), but also could be a curable polymer that solidifies or bonds upon activation by one or more wavelengths of light (e.g. infrared or ultraviolet). In such a case, the light would be applied to the adhesive layer 204 immediately before the first portion 206 is brought into contact with the second portion 209, so that the adhesive layer 204 would be activated but not yet cured until contacted by the second portion 209 of the second side 208 of the tape 200. Alternatively, the adhesive layer 204 could be heat activated or microwave activated in which case, the first and second portions 206 and 209 may be brought into contact before heat or microwave energy is applied to the tape 200. Alternatively, the adhesive layer 204 may be considered a first adhesive layer 204 and the second portion may include a coating of a second adhesive layer. The first adhesive layer 204 is formed of a first material, and the second adhesive layer is formed of a second material, different from the first material, wherein the first and second materials function as a binary compound which when combined and activated creates a sealed adhesion, but the first and second materials are not tacky individually prior to activation. Alternatively, the first and second portions 206 and 209 may not include an adhesive layer, and heat is used to partially melt the materials within the first and second portions 206 and 209 together into a sealed adhesion with each other.

In a preferred embodiment, the adhesive layer 204 solely exists between, i.e., is sandwiched between, two portions of the sheet 202, so that none of the adhesive layer 204 contacts the cable core or is visible on the exterior of the cable 10 to collect dirt. In other embodiments, a mild adhesive, with a much lower adhesive strength than the adhesive layer 204, may be located on portions of the tape 200 in contact with the cable core to slight adhere the tape 200 to the cable core. In some cases, the adhesive layer 204 may not extend entirely to the first longitudinal edge 205. If the tape 200 is wrapped about the cable core so that the first longitudinal edge 205 is visible, then a short, disconnected flap will exist at the second longitudinal edge 205. The flap may be useful in tearing the tape 200 from the cable core in a mid-span access operation for splicing purposes. The flap could also be created when the second longitudinal edge 203 is visible by pulling the second longitudinal edge 203 completely over the first portion 206 to slightly over hang the first portion 206.

The adhesive layer 204 of the first portion 206 may form between 1% and 40% of the first side 201 of the sheet 202, such as 10% to 30%, or about 15% to 20%. The sheet 202 may be formed of a plastic or polymer such as polypropylene, polyester, vinyl, acrylic, Ethylene-vinyl acetate (EVA), acetate, rubber, Velostat, cellophane, silicone, or a combination thereof. The sheet 202 may be strengthened by cloth fibers, such as cotton, artificial fibers, fiberglass or black carbon. The material of the tape 200 is preferably UV stable and abrasion resistant, yet capable of being torn using fingernails or a blunt tool. The exposed side of the tape 200, i.e., facing away from the cable core, preferably has a low coefficient of friction. In an alternative or supplemental embodiment, the sheet 202 is formed of a heat-shrinking material, such that an application of heat will case the tape 200 to shrink down into a tight fit with the cable core.

FIG. 3 depicts a cable 300, e.g., a fiber optic cable, twisted-pair cable, or hybrid cable, where a portion of tape 200 has been removed to expose a cable core 301 within the cable 300. The overlapped portion A of the tape 200 extends longitudinally, parallel to a central axis of the cable 300. To remove a midportion of the tape 200, as shown in FIG. 3, a technician need only sever, e.g., using fingernails or a blunt tool, the overlapped portion A of the tape 200 in two locations. The tape 200 can then be manually torn, e.g., with the technician's fingers, in a circle around the cable core at the two locations, and then manually torn free longitudinally along a single tear line between the two locations.

FIG. 3 would be the first step to performing a mid-span splicing operation. For example, a buffer tube could be cut and the cut end separated from the cable core 301. An optical fiber therein could be spliced to another optical fiber, e.g., within a drop cable, to be routed away to an end user's device. The splice could occur within a Certi-Seal™ enclosure, as sold by the present Assignee. The enclosure would be abutted to the exposed cable core 301, and optionally zip tied to the cable core 301. Lastly, a section of tape 200, carried by the field technician, could be used to wrap the enclosure to the cable core, covering all of the enclosure and the remaining exposed sections of the cable core 301, so as to re-establish the integrity of the weather-tight seal of the tape 200 across the entire site of the splicing operation on the cable 300.

The cable 300 may include optical fibers, twisted-pairs, insulated electrical conductors, coaxial cables, filler rods, fibrous strength members, GRP rods, binders, core wraps, separators, water-blocking tapes, rip cords, and/or all other elements commonly known to exist in cable cores. The cable core may be stranded, e.g., S-Z stranded, and previously bundled and attached by one or more binders 69 or paper core wraps prior to the application of the tape 200. Alternatively, the cable core may be loosely combined and held together primarily by the tape 200.

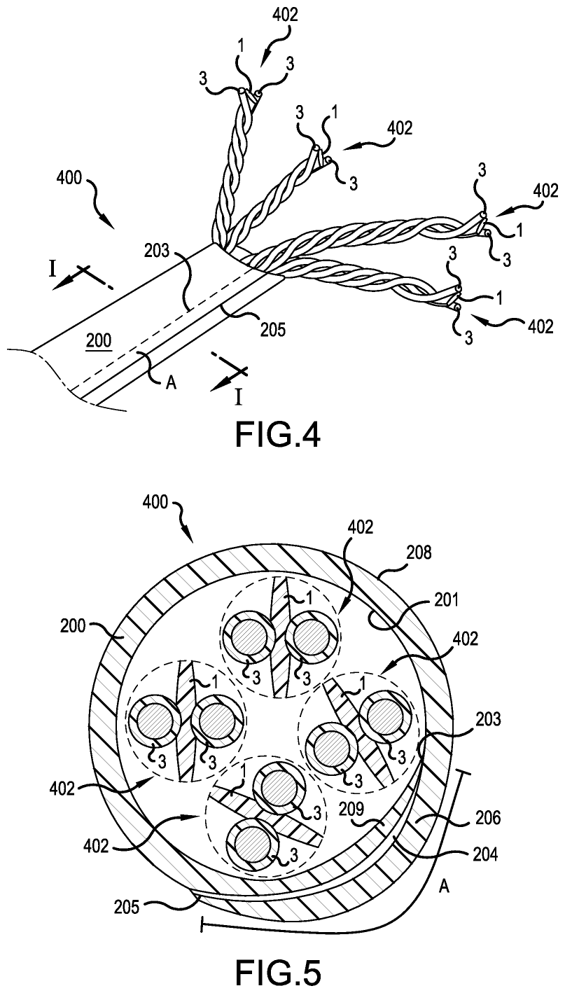

FIG. 4 depicts the tape 200 applied to a twisted-pair cable 400 including four twisted-pairs 402. Each twisted pair 402 includes two insulated conductors 3 and a dielectric spacer 1 therebetween, where the dielectric spacers 1 play a role in impedance matching and balancing delay shew between twisted pairs 402 having different twist lays. The number of twisted pairs 402 is purely exemplary and any number of twisted pairs 402 may be wrapped by the tape 200. The adhesive layer 204 is located within the overlapped portion A of the sheet 202 forming the tape 200. The cable core may also include one or more separators to improve internal crosstalk performance and/or one or more shielding layers to improve both internal and alien crosstalk.

FIG. 5 depicts a cross sectional view of the twisted-pair cable 400, taken along line I-I in FIG. 4. The dotted lines illustrate spaces occupied by the twisted pairs 402 as they twist within the cable core. The tape 200 attains a substantially circular cross-sectional profile for enclosing the four twisted pairs 402, since the twisted pairs 402 are also core stranded. However, the cross-sectional profile of the tape 200 need not be circular and may take other shapes, such as triangular if the tapes 200 were surrounding three insulated power cables with no core stranding.

The overlapped portion A of the tape 200 is formed of two sections of sheet 202 and the adhesive layer 204. In FIG. 5, the adhesive layer 204 on the first side 201 faces toward the cable core, while the second side 208 faces away from the cable core and is exposed on the outside of the cable 400, except for the overlapped second portion 209 of the second side 208.

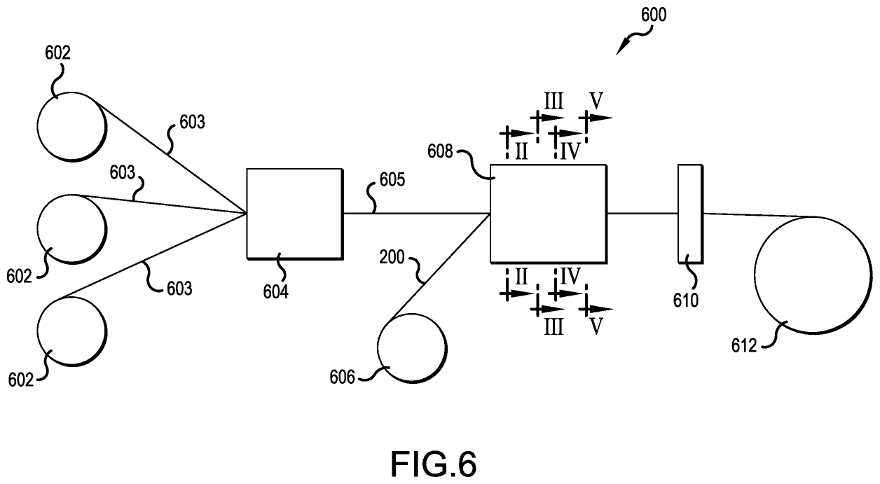

FIG. 6 illustrates a manufacturing system 600 for applying the tape 200 as a jacket to a cable core to form the cable 10, 300 or 400. The system 600 includes one or more cable reels 602, each dispensing a cable element 603, e.g., a buffer tube with an optical fiber therein, a twisted-pair, an insulated conductor. The cable elements 603 are feed to a bundler 604 which relieves or equalizes any tensions between the cable elements 603 and groups the cable element 63 into a cable core 605. The bundler 604 may optionally strand the cable elements 603 to form the cable core 605, such as a helical strander or a SZ strander, in which case one or more binder threads 69 may be installed to hold the stranded cable core 605 together as it leaves the strander. One such strander is provided in U.S. Pat. No. 4,939,896 to Douglas Blew the entire disclosure of which is incorporated herein by reference.

The cable core 605 exiting the bundler 604 may then proceed to the tape applicator 608. The tape applicator 608 may also receive tape 200 from spool or reel 606. In one embodiment, the reel 606 contains a coil of the sheet 202, which is fed to the tape applicator 608 directly from the reel 606 by one or more idling or driven guides or pulleys. The tape applicator 608 applies the adhesive layer 204 to the first portion 206 of the sheet 202 to form the tape 200. The tape applicator 608 may also adapt the width dimension of the adhesive layer 204 applied to the sheet 202 and may also adjust the overall width of the sheet 202 by cutting and discarding a portion of the sheet 202 from one or both of the first and second longitudinal edges 205 and 203, so that the tape 200 is sized appropriately for the diameter of the cable core 605. Alternatively, a tape 200 of the appropriate width, with the adhesive layer 204 already applied thereto, may be stored on the reel 606 and fed to the tape applicator 608.

The cable elements 603 may be bundled by the bundler 604 at the maximum line speed of the bundler 604. Then, the cable core 605 may pass through the tape applicator 608 at the same speed. In other words, the tape applicator 608 is designed to function as fast as the line speed of the bundler 604 and is designed to not be the bottleneck in the cable manufacturing process. Other more complex outer jacketing techniques, e.g., extrusions of polymer jackets and/or a helically wrapped tape, must often be ran at line speeds which are slower than the maximum line speed of the bundler 604. As a result, the jacketing process is the bottleneck, leading to slower production of the cable 10, 300, 400, e.g., less feet of cable 10, 300, 400 per minute. The longitudinal application of the tape 200 to the cable core 605, quick bonding action of the adhesive layer 204, and no cooling requirements, may alleviate this bottleneck in line speed.

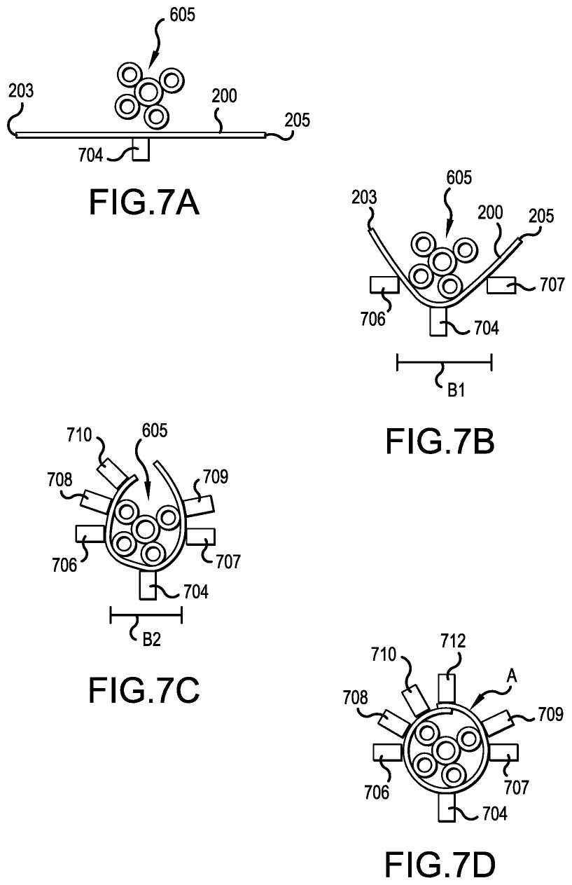

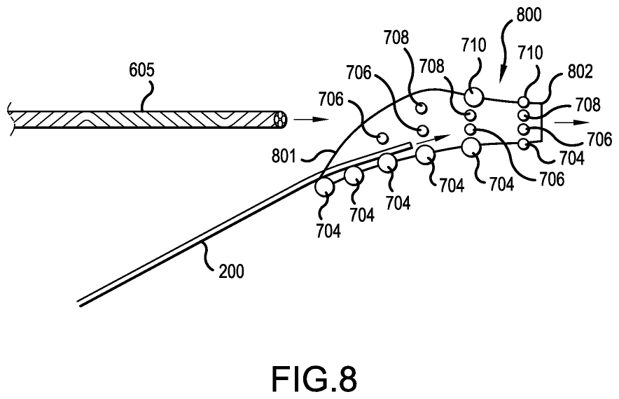

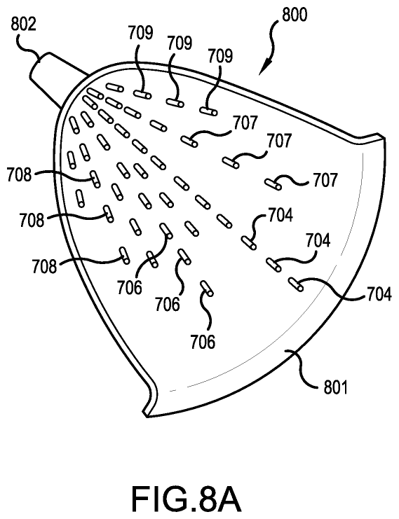

One embodiment of the internal mechanisms of the tape applicator 608 may be seen in the cross-sectional views of FIGS. 7A, 7B, 7C and 7D, as taken along lines II, III, IV and V, respectively, in FIG. 6. FIG. 8 is a side view of the internal mechanisms within the tape applicator 608 and FIG. 8A is a perspective view of a guide profile 800 within the tape applicator 608. In one embodiment, the guide profile 800 is illustrated as having partial funnel shape, which closes in from an upstream entrance 801 toward a downstream exit 802. In general, strings of guide elements are attached to the guide profile 800 and form a general funnel shape, or at least one side of a funnel initially, that leads to a full funnel, finally. The strings of guide elements progressively wrap the tape 200 around the cable core 605.

As best seen in FIG. 7A, after the tape 200 enters the tape applicator 608, an idling and/or driven first guide element 704 brings a central section of the tape 200 into abutment with the cable core 605. The tape 200 is then travelling parallel to the cable core 605 and at a same speed as the cable core 605. Additional first guide elements 704 may be provided downstream from the cross-sectional view of line II-II.

The guide elements illustrated in each of cross-sectional views of FIG. 7A-7D, 8 and 8A that share the same reference numbers share the same “o'clock” position within the guide profile 800, from the entrance 801 to the guide profile 800 until the exit 802 from the guide profile 800. Also, the guide elements may be separate guide elements of the roller type with a rotation axis or of the captured ball type which may roll in any direction. The guide profile 800 is best depicted in the representative perspective view of FIG. 8A. The first guide element 704 in FIG. 7A brings the center of the tape 200 into contact with the cable core 605, and the remaining first guide elements 704 keep the center of the tape 200 in contact with the cable core 605.

At cross sectional line III-III, as depicted in FIG. 7B, two additional second guide elements 706 and 707 start the wrapping process and move the right and left side portions of the tape 200 into contact with the cable core 605, causing the tape 200 to assume an open V-shape. At cross sectional line IV-IV, as depicted in FIG. 7C, additional third guide elements 708, 709 and 710 continue the wrapping process and move the right and left side portions of the tape 200 into additional contact with the cable core 605, causing the tape 200 to assume a closed U-shape. At cross sectional line V-V, as depicted in FIG. 7D, an additional third guide elements 712 continues the wrapping process and moves the second longitudinal edge 205 into abutment with the second portion 209 of the tape 200, causing the tape 200 to assume a substantially circular cross sectional profile. The configuration of FIG. 7D relates to the contact occurring between the first and second portions 206 and 209 of the tape 200, as previously described.

In general, the guide elements 704, 706, 707, 708, 709, 710 and 712 shape the curvature of the tape 200, as the tape 200 and the cable core 605 progress through the tape applicator 608 at the speed the cable core 605 is being dispensed from the bundler 604. Guide elements 704, 706, 707, 708, 709, 710 and 712 may form part of a funnel-shaped guide profile 800, as seen in FIGS. 8 and 8A. As depicted, the sequence of guide elements 706 may face opposite to the sequence of guide elements 707. In FIG. 7B, the guide elements 706 and 707 are spaced apart as noted by width B1. In FIG. 7C, the guide elements 706 and 707 are spaced apart as noted by width B2, where width B2 is smaller than width B1. Thus, between FIG. 7B and FIG. 7C, the sequence of guide elements 706 and 707 deflect the tape 200 closer to the cable core 605 and eventually into close contact with the cable core 605, as the tape 200 and cable core 605 progress through the tape applicator 608.

In FIG. 7C, the sequence of guide elements 708 and 709 face to each other and may similarly become progressively closer together along the guide profile 800, as the tape 200 and cable core 605 progress toward the position depicted in FIG. 7D. The guide elements 710 and 712 move the second longitudinal edge 203 of the tape 200 into abutment with the cable core 605 and the first longitudinal edge 205 into abutment with the tape 200 to form the overlapped portion A (FIGS. 3, 4 and 5) of the tape 200, as the tape 200 and cable core 605 progress toward the position depicted in FIG. 7D. More specifically, in FIG. 7D, the guide element 712 comes into play to close and/or seal the tape 200 around the cable core 605. Additional guide elements 712 downstream of cross sectional view V in the tape applicator 608 may move closer to the cable core 605 to apply additional pressure and/or localized heat to perfect or ensure a good seal is being formed in the overlapped portion A of the tape 200.

The guide elements 704, 706, 707 and 712 may be positioned substantially perpendicularly, such that guide elements 706 and 707 lie in a first plane and guide elements 704 and 712 lie in a second plane perpendicular to the first plane. Additional intermediate guide elements may also be provided between the guide elements shown in FIGS. 7A-7D, both radially and longitudinally, such as those depicted in FIG. 8A. The intermediate guide elements would provide for a smoother transition and wrapping of the tape 200 about the cable core 605. More specifically, one or more guide elements 704 may be positioned between cross sectional views II and III, between cross sectional views III and IV, between cross sectional views IV and V, and/or downstream of cross-sectional view V. One or more guide elements 706 and 707 may be positioned between cross sectional views II and III, between cross sectional views III and IV, between cross sectional views IV and V and/or downstream of cross-sectional view V within the tape applicator 608. One or more guide elements 708, 709 and 710 may be positioned between cross sectional views III and IV, between cross sectional views IV and V and/or downstream of cross-sectional view V within the tape applicator 608. One or more guide elements 712 may be positioned between cross sectional views IV and V and/or downstream of cross-sectional view V within the tape applicator 608.

As noted previously, the first side 201 of the sheet 202 may have the adhesive layer 204. If the first side 201 is to contact any of the guide elements 704, 706, 707, 708, 709, 710 and 712, the guide elements 704, 706, 707, 708, 709, 710 and 712 may be lubricated or otherwise treated to not stick to the adhesive layer 204. In a preferred embodiment, the adhesive layer faces toward the cable core 605 (upward in FIGS. 7A-7D and therefore does not contact the guide elements 704, 706, 707, 708, 709, 710 and 712, especially when the adhesive layer 204 is formed as a gummy or tacky layer.

In other embodiments, the adhesive layer 204 is not tacky, e.g., it needs to be activated by heat, light, microwave energy, or contact with a secondary agent to form a binary adhesive. In such instances, the tape 200 wrapped about the cable core 605 may be passed through an activator device 610. Although the activator device 610 is illustrated as being separate from the tape applicator 608, the activator device 610 may be integrally formed within the tape applicator 608 toward a downstream end of the tape applicator 608.

The activator device 610 acts to cure the adhesive layer 204 and may produce pressure, heat, microwaves or light. In the case of a light cured adhesive, e.g., an adhesive that activates and adheres a few seconds after an exposure to UV light, it would be best to expose the first portion 206 of the tape along the first longitudinal edge 205 to the proper wavelength of light just prior to contacting the first portion 206 to the second portion 209. Hence, the light source would be located within the tape applicator 608 between the cross-sectional views of FIGS. 7C and 7D. If the activator device 610 produces heat, it may be beneficial to form the entire sheet 202 of the tape 200 out of a heat shrinking polymer. As such, the tape 200 will shrink down onto the cable core 605 in a tight fit to produce a minimum diameter cable 10, 300, 400. A collection reel 612 is located downstream of the activator device 610 and takes up the finished cable 10, 300, 400 for storage and shipping.

The guide elements 704, 706, 707, 708, 709, 710 and 712 may be driven to pull cable core 605 and tape 200 in the downstream direction, as indicated by the rightward facing arrows in FIG. 8. However, in a preferred embodiment, the guide elements 704, 706, 707, 708, 709, 710 and 712 are free wheeling or idling rollers, balls or bearings, and the cable core 605 and tape 200 are pulled through the guide profile 800 by driving rotation of the collection reel 612 or one or more driven pulleys, belts and/or rollers positioned between the exit 802 of the guide profile 800 and the collection reel 612. A primary function of the guide elements 704, 706, 707, 708, 709, 710 and 712 is to reduce friction between the tape 200 and guide profile 800, as the tape is shaped around the cable core 605 at high speeds.

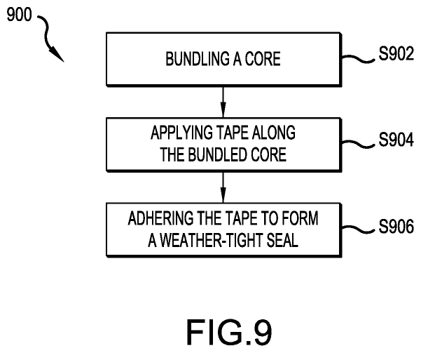

FIG. 9 provides an overview of a process 900 of applying the tape 200 to the cable core 605 to form the cable 10, 300, 400. At S902, the process may bundle two or more communication carrying mediums, e.g., buffer tubes with one or more optical fibers therein, potentially along with other elements into the cable core 605. For example, the cable core 605 could include buffer tubes with one or more optical fibers, twisted-pairs, insulated electrical conductors, coaxial cables, filler rods, separators, fibrous strength members, GRP rods, binders, core wraps, water-blocking tapes, rip cords, and/or all other elements commonly known to exist in cable cores. The bundling S902 is performed by the bundler 604 which may draw from two or more reels 602.

Next, in S904, the tape 200 is applied along the cable core 605. The applying S904 is accomplished by the tape applicator 608. The line speed of the tape applicator 608 matches the line speed of the bundler 604, such that the cable core 605 is wrapped with the tape 200 at the same speed as the cable core 605 is formed by the bundler 604. The tape 200 may be applied to the cable 10, 300, 400 in the tape applicator 608 longitudinally, such that the overlapped portion A remains parallel to the travel direction of the cable core 605 through the guide profile 800, and is not wound, twisted, or rotated about the cable core 605.

At S906, the tape 200 that was applied to the cable core 605 in the tape applicator 608 has a first portion 206 thereof adhered to a second portion 209 thereof so as to form a weather-tight seal. As previously described the adhering process may optionally include pressure, heat, microwave energy, or the application of light of a particular wavelength. The weather-tight seal may also be optionally supplemented by heat shrinking the tape 200 to contract the tape 200 into close contact with the cable core 605. The linear speed of the cable 10, 300, 400 during the adhering process S906 is the same as the linear speed of the bundler 604 and tape applicator 608.

The foregoing embodiments are illustrative of the present invention, and are not to be construed as limiting thereof. Although exemplary embodiments of this invention have been described, those skilled in the art will readily appreciate that many modifications are possible in the exemplary implementations without materially departing from the novel teachings and advantages of this invention. Accordingly, all such modifications are intended to be included within the scope of this invention as defined in the claims. The invention is defined by the following claims, with equivalents of the claims to be included therein.

1. A communication cable comprising:
a core including at least one communication carrying medium;
a tape having first and second longitudinal edges, said first and second longitudinal edges extending parallel to a central axis of said core; and
an adhesive layer disposed on a first side of said tape in a first portion proximate said first longitudinal edge, a second portion of said tape proximate said second longitudinal edge overlapping said adhesive layer proximate said first longitudinal edge, such that said second portion is adhered to said first portion and said tape encloses said core along a length of said communication cable.

2. The communication cable of claim 1, wherein said second portion is on a second side of said tape.

3. The communication cable of claim 1, wherein said second portion of said tape completely overlaps said adhesive layer.

4. The communication cable of claim 1, wherein said adhesive layer is a first adhesive layer and further comprising:
a second adhesive layer disposed on said second portion of said tape.

5. The communication cable of claim 4, wherein said first adhesive layer is formed of a first material, and said second adhesive layer is formed of a second material, different from said first material, and wherein said first and second materials function as a binary compound which activates upon combination to create a sealed adhesion.

6. The communication cable of claim 1, wherein said adhesive layer is activated to seal said first and second portions together by at least one of pressure, heat, microwaves or light.

7. The communication cable of claim 1, wherein said tape is shrink-fitted onto said core.

8. The communication cable of claim 3, wherein said second portion is larger than said first portion and extends circumferentially about said core beyond said adhesive layer to form a short, disconnected flap.

9. The communication cable of claim 1, wherein said at least one communication carrying medium includes plural buffer tubes, each containing at least one optical fiber.

10. A communication cable comprising:
a core including at least one communication carrying medium;
a tape having first and second longitudinal edges, said first and second longitudinal edges extending parallel to a central axis of said core, wherein a first portion is disposed on a first side of said tape proximate said first longitudinal edge and overlaps a second portion disposed on a second side of said tape proximate said second longitudinal edge; and
an attachment formed between said first and second portions, such that said tape encloses said core along a length of said communication cable.

11. The communication cable of claim 10, wherein said attachment is the result of at least a partial melting of said first and second portions together.

12. The communication cable of claim 10, further comprising:
an adhesive positioned between said first and second portions to said form said attachment.

13. The communication cable of claim 12, wherein said adhesive is activated to form said attachment by at least one of pressure, heat, microwaves or light.

14. A method of applying a tape to a cable core, comprising:
advancing the cable core along a first path following a longitudinal axis of the cable core;
advancing the tape along a second path to intersect the first path, the tape having a first longitudinal edge and a second longitudinal edge;
engaging the tape with one or more first guide elements as the tape is advancing, the one or more first guide elements causing a central portion of the tape between the first and second longitudinal edges of the tape to engage the cable core;
engaging the tape with one or more second guide elements to move the first and second longitudinal edges of the tape toward each other so as partially encircle the cable core;
engaging the tape with one or more third guide elements to press a first portion disposed on a first side of the tape proximate the first longitudinal edge against a second portion disposed on a second side of the tape proximate the second longitudinal edge so as to fully encircle the cable core; and
attaching the first and second portions together so that the tape seals the cable core.

15. The method of claim 14, further comprising:
applying an adhesive along at least one of the first or second portions prior to attaching the first and second portions together.

16. The method of claim 14, further comprising:
bundling multiple buffer tubes, each containing at least one optical fiber, together to form the cable core.

17. The method of claim 16, wherein the tape has an adhesive layer preformed as a longitudinal strip residing within the first portion on the first side of the tape proximate the first longitudinal edge, and further comprising:
paying the tape off of a spool prior to advancing the tape along the second path.

18. The method of claim 14, wherein advancing the cable core is done at a same linear speed as advancing the tape.

19. The method of claim 14, wherein attaching the first and second portions together so that the tape seals the cable core further includes at least one of applying heat, microwave energy or light to the tape after or just before the first and second portions are pressed against each other by the one or more third guide elements.

20. The method of claim 14, further comprising:
shrinking the tape onto the cable core by a heating process, after or during the attaching of the first and second portions together.
